(19) United States
(12) Patent Application Publication
(10) Pub. No.: US 2005/0221691 A1
(43) Pub. Date: Oct. 6, 2005

(54) Wire terminal with clamping sections having milled grooves

(76) Inventor: Mu-Te Li, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/095,457

(22) Filed: Apr. 1, 2005

(30) Foreign Application Priority Data
Apr. 5, 2004 (CN) 200420047895.6

(51) Int. Cl. H01R 4/24

(52) U.S. Cl. 439/886

(57) ABSTRACT

A wire terminal includes a connecting terminal, a core wire clamping section for tightly clamping bare core wires of an electric wire connected to the wire terminal, and an insulating wire sheath clamping section for tightly clamping a portion of an insulating wire sheath of the electric wire immediately behind the bare core wires. The core wire clamping section and the insulating wire sheath clamping section are provided at respective inner surface with a plurality of grooves by way of milling, and each of the milled grooves extends from one lateral end to the other lateral end of the clamping sections.

### FIELD OF THE INVENTION

The present invention relates to a wire terminal with clamping sections having milled grooves, and more particularly to a wire terminal having a plurality of milled grooves provided at inner surfaces of two clamping sections formed on the wire terminal.

### BACKGROUND OF THE INVENTION

In FIG. 1, there is shown an integral body 1 of a conventional wire terminal, on which a connecting terminal 11, a core wire clamping section 12, an insulating wire sheath clamping section 13, a plurality of pressed grooves 121, and a material belt 14 are formed.

Please refer to FIG. 1A that is a side view of the conventional wire terminal of FIG. 1, and to FIG. 1B that is a sectional view taken along line IB-IB of FIG. 1. The grooves 121 are formed on an inner surface of the core wire clamping section 12 by way of pressing, such that a plurality of protruded strips 122 are formed on an outer surface of the core wire clamping section 12 corresponding to the pressed grooves 121. While the protruded strips 122 enable an enhanced contact force between the core wire clamping section 12 and the core wires of an electric wire connected to the wire terminal 1, they also result in reduced structural stress and shear force of the core wire clamping section 12.

The material belt 14 is located behind the insulating wire sheath clamping section 13. With the material belt 14, a plurality of wire terminals 1 could be continuously parallelly connected together in the process of manufacturing the wire terminals.

Most conventional wire terminals have a structure similar to that shown in FIG. 1. However, the connecting terminals 11 of the conventional wire terminals may be differently shaped, depending on the electric apparatus to which the wire terminals are connected. FIGS. 2A to 2F illustrate some of the connecting terminal shapes most frequently adopted in conventional wire terminals. FIG. 2A shows an R-shaped connecting terminal 11A, FIG. 2B shows a connecting terminal 11B in the form of a round tubular socket, FIG. 2C shows a flag-shaped connecting terminal 11C, FIG. 2D shows a connecting terminal 11D in the form of a bullet-shaped male plug, FIG. 2E shows a connecting terminal 11E in the form of a pointed male plug, and FIG. 2F shows a connecting terminal 11F in the form of a rectangular socket. Of course, there are still many other shapes available for the connecting terminals of conventional wire terminals, such as needle-shaped, flat pin-shaped connecting terminals, etc.

An electric wire generally includes core wires consisting of a plurality of twisted fine wires. When the core wire clamping section 12 in the conventional wire terminal 1 clamps the core wires, a low contact force presents between the clamping section 12 and the core wires, resulting in an insufficient pull resistance at the core wire clamping section 12, and accordingly, degraded electrical connection via the wire terminal 1.

Particularly, it is possible to have thermal expansion at the core wire clamping section 12 due to a high amount of current flown through the electric wire, which causes a loosened core wire clamping section 12 from the electric wire, and accordingly, poor electrical conduction and dangers in using the electrical apparatus connected to the electric wire.

Moreover, the conventional wire terminal is usually provided at the clamping sections with conducting sharp points to facilitate firm clamping of the core wires or the wire sheath by the clamping sections. However, these conducting sharp points would also undesirably scratch or damage the core wires and/or the wire sheath, which in turn results in leakage of current in the apparatus connected to the wire terminal. It is particularly possible to have a leaking apparatus when the apparatus using the above-structured wire terminal operates in a high-voltage and high-current environment.

### SUMMARY OF THE INVENTION

It is therefore a primary object of the present invention to provide a wire terminal with clamping sections having milled grooves, which enables a connecting interface between electrical apparatus to have high pull resistance, high electrical safety, and high durability in use.

To achieve the above and other objects, the wire terminal according to the present invention includes a connecting terminal, a core wire clamping section for tightly clamping bare core wires of an electric wire connected to the wire terminal, and an insulating wire sheath clamping section for tightly clamping a portion of an insulating wire sheath of the electric wire immediately behind the bare core wires. The core wire clamping section and the insulating wire sheath clamping section are provided at respective inner surface with a plurality of grooves by way of milling, and each of which extends from one lateral end to the other lateral end of the clamping sections.

The wire terminal of the present invention has effectively enhanced overall performance, including increased structural stress, contacting force, pull resistance, electrical safety, and electrical conductivity, and is therefore practical and safe for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front plan view of a conventional wire terminal;

FIG. 1A is a side view of the conventional wire terminal of FIG. 1;

FIG. 1B is a sectional view taken along line IB-IB of FIG. 1;

FIG. 2A is a fragmentary plan view of an R-shaped connecting terminal for a conventional wire terminal;

FIG. 2B is a fragmentary perspective view of a connecting terminal in the form of a round tubular socket for a conventional wire terminal;

FIG. 2C is a fragmentary perspective view of a flag-shaped connecting terminal for a conventional wire terminal;

FIG. 2D is a fragmentary perspective view of a connecting terminal in the form of a male plug for a conventional wire terminal;

FIG. 2E is a fragmentary plan view of a connecting terminal in the form of a pointed male plug for a conventional wire terminal;

FIG. 2F is a fragmentary perspective view of a connecting terminal in the form of a rectangular socket for a conventional wire terminal;

FIG. 3 is a front plan view of a wire terminal with clamping sections having milled grooves according to a first embodiment of the present invention;

FIG. 4 is a side view of the wire terminal of FIG. 3;

FIG. 5 is a sectional view taken along line 5-5 of FIG. 3;

FIG. 6 is a fragmentary plan view showing an R-shaped connecting terminal for a wire terminal according to a second embodiment of the present invention;

FIG. 7 is a fragmentary perspective view showing a connecting terminal in the form of a round tube with protruded and recessed contacts for a wire terminal according to a third embodiment of the present invention;

FIG. 8 is of a side view of a wire terminal with clamping sections having milled grooves according to a fourth embodiment of the present invention;

FIG. 9 is of a side view of a wire terminal with clamping sections having milled grooves according to a fifth embodiment of the present invention; and

FIG. 10 is of a side view of a wire terminal with clamping sections having milled grooves according to a sixth embodiment of the present invention.

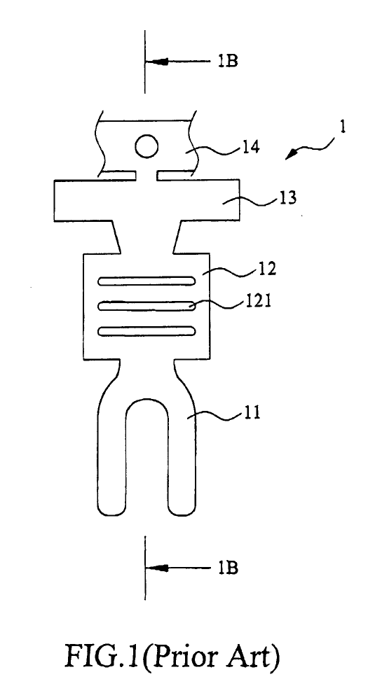

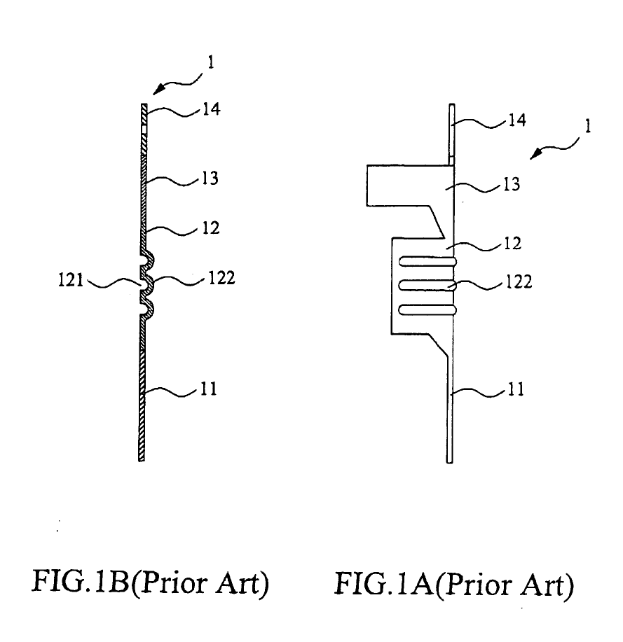

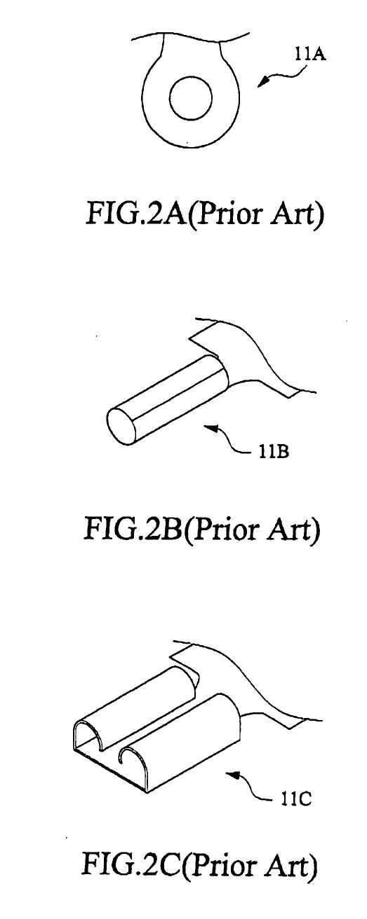

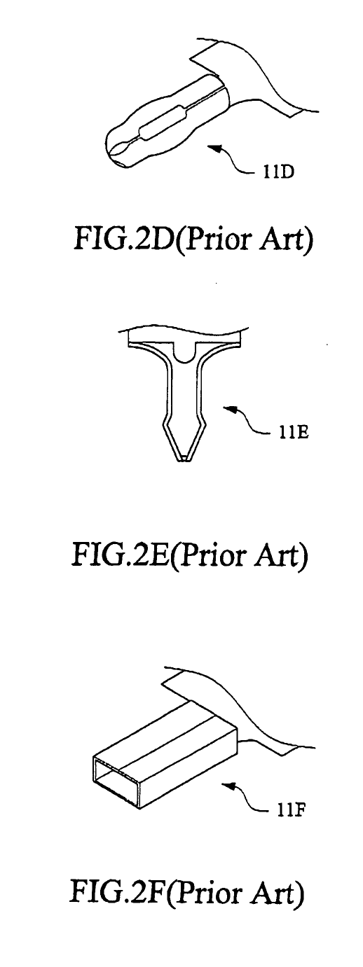

### DETAILED DESCRIPTION OF THE PREFERRED EMBODIMENTS

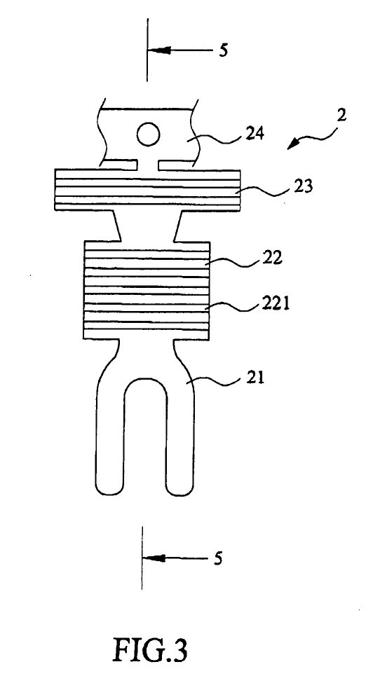

Please refer to FIG. 3 that is a front plan view of a wire terminal with clamping sections having milled grooves according to a first embodiment of the present invention. As shown, the wire terminal has an integral body 2 having a connecting terminal 21, a core wire clamping section 22, and an insulating wire sheath clamping section 23 formed thereon. The core wire clamping section 22 is provided at an inner surface with a plurality of grooves 221 by way of milling, and each of the milled grooves 221 continuously extends from one lateral end to the other lateral end of the core wire clamping section 22.

The insulating wire sheath clamping section 23 is located behind the core wire clamping section 22 relative to the connecting terminal 21, and is provided at an inner surface with a plurality of grooves 231 by way of milling. While the core wire clamping section 22 is used to tightly clamp bare core wires of an electric wire (not shown), the insulating wire sheath clamping section 23 is used to tightly clamp a portion of an insulating wire sheath of the electric wire immediately behind the bare core wires.

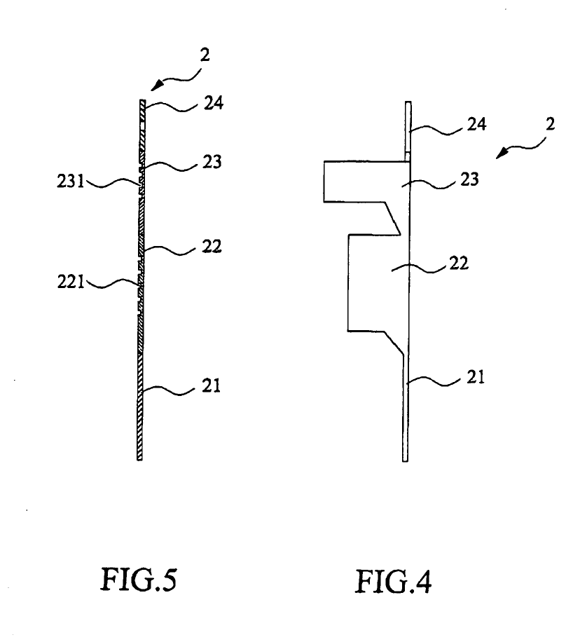

As can be seen from FIGS. 4 and 5, which are side and sectional views, respectively, of the wire terminal of FIG. 3, the core wire clamping section 22 and the insulating wire sheath clamping section 23 have a flat outer surface without any protruded strip formed thereon. Therefore, the milling of the grooves 221, 231 on the inner surfaces of the two clamping sections 22, 23 would not reduce any mechanical strength of the whole wire terminal of the present invention.

The integral body 2 also includes a material belt 24 formed behind the insulating wire sheath clamping section 23. With the material belt 24, a plurality of integral bodies 2 of the wire terminals of the present invention are continuously and parallelly connected together.

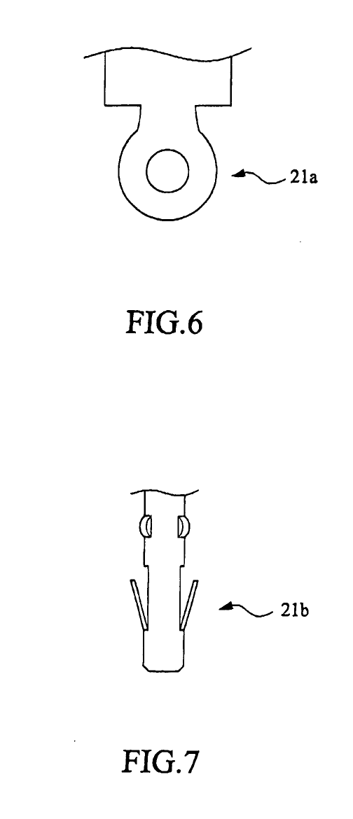

FIG. 6 is a fragmentary plan view of a wire terminal according to a second embodiment of the present invention. The wire terminal of the second embodiment is generally structurally similar to the first embodiment shown in FIG. 3, except for an R-shaped connecting terminal 21a.

FIG. 7 is a fragmentary perspective view of a wire terminal according to a third embodiment of the present invention. The wire terminal of the third embodiment is generally structurally similar to the first embodiment shown in FIG. 3, except for a connecting terminal 21b in the form of a round tube with protruded and recessed contacts.

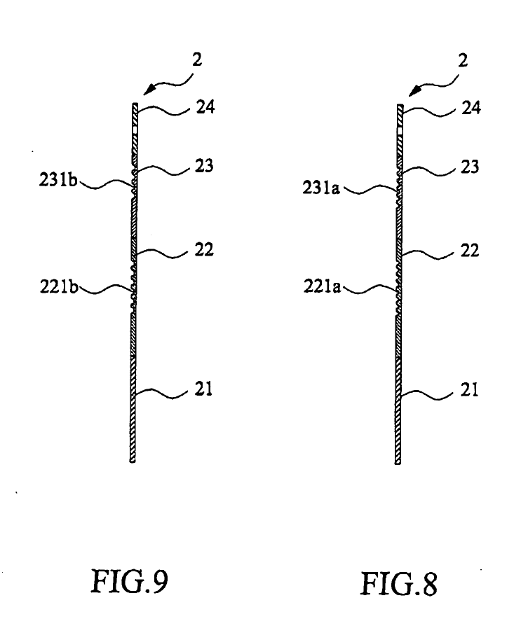

FIG. 8 is a side view of a wire terminal with clamping sections having milled grooves according to a fourth embodiment of the present invention. The wire terminal of the fourth embodiment is substantially identical to the wire terminal of the first embodiment with reference to FIG. 5. However, in the first embodiment, the grooves 221, 231 of the core wire clamping section 22 and the insulating wire sheath clamping section 23 have a U-shaped configuration with a flat top and a flat bottom, while in the fourth embodiment, the grooves 221a, 231a of the core wire clamping section 22 and the insulating wire sheath clamping section 23 have a generally U-shaped configuration with a round top and a flat bottom.

FIG. 9 is a side view of a wire terminal with clamping sections having milled grooves according to a fifth embodiment of the present invention. The wire terminal of the fifth embodiment is substantially identical to the wire terminal of the fourth embodiment with reference to FIG. 8. However, in the fifth embodiment, the grooves 221, 231 of the core wire clamping section 22 and the insulating wire sheath clamping section 23 have a generally U-shaped configuration with a round top and a flat bottom, while in the fifth embodiment, the grooves 221b, 231b of the core wire clamping section 22 and the insulating wire sheath clamping section 23 have a corrugated configuration with a round top and a round bottom.

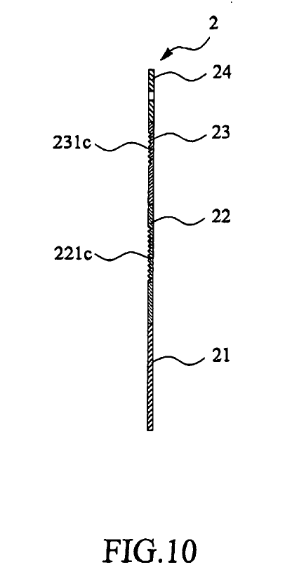

FIG. 10 is a side view of a wire terminal with clamping sections having milled grooves according to a sixth embodiment of the present invention. In this embodiment, the grooves 221c, 231c of the core wire clamping section 22 and the insulating wire sheath clamping section 23 have a saw-tooth shaped configuration with a sharp top and a shape bottom.

It is understood there are still many other shapes available for the connecting terminal 21 of the wire terminal of the present invention. For example, the connecting terminal 21 may be a flat member with protruded and recessed contacts, a folding member with protruded and recessed contacts, or a square member with protruded and recessed contacts.

1. A wire terminal with clamping sections having milled grooves, comprising an integral body having a connecting terminal formed at an end thereof, and at least one core wire clamping section closely formed behind said connecting terminal for tightly clamping bare core wires of an electric wire connected to said integral body; said wire terminal being characterized in that said core wire clamping section is provided at an inner surface with a plurality of grooves by way of milling.

2. The wire terminal with grooved clamping sections as claimed in claim 1, wherein each of said milled grooves continuously extends from one lateral end to the other lateral end of said core wire clamping section.

3. The wire terminal with grooved clamping sections as claimed in claim 1, wherein said integral body further has an insulating wire sheath clamping section formed behind said core wire clamping section relative to said connecting terminal for tightly clamping a portion of an insulating wire sheath of the electric wire immediately behind said bare core wires clamped by said core wire clamping section.

4. The wire terminal with grooved clamping sections as claimed in claim 3, wherein said insulating wire sheath clamping section is provided at an inner surface with a plurality of grooves by way of milling.
